(19) United States
(12) Patent Application Publication
(10) Pub. No.: US 2026/0177024 A1
(43) Pub. Date: Jun. 25, 2026

(54) PRESSURE REGULATOR VALVE FOR ENGINE FUEL SYSTEM

(71) Applicant: Cummins Inc., Columbus, IN (US)

(72) Inventors: Sandip V. Patil, Pune (IN); Juilee V. Kale, Columbus, IN (US); Ross A. Phillips, Columbus, IN (US); Amol Jagannath Bobade, Pune (IN)

(21) Appl. No.: 19/127,874

(22) PCT Filed: Oct. 26, 2023
(86) PCT No.: PCT/US23/77904

§ 371 Date: May 7, 2025

Related U.S. Application Data
(60) Provisional application No. 63/383,558, filed on Nov. 14, 2022.

(51) Int. Cl. F02M 59/34; F02M 37/00; F02M 55/02; F02M 59/10

(52) U.S. Cl. CPC F02M 59/34; F02M 37/0052; F02M 55/025; F02M 59/102

(57) ABSTRACT

A fuel system for an internal combustion engine includes a low pressure fuel pump and a pressure regulator valve. The pressure regulator valve is placed at the inlet to the low pressure fuel pump to regulate the fuel pressure and fuel flow in the system.

### CROSS-REFERENCE TO RELATED APPLICATION

The present application claims priority to, and the benefit of the filing date of, U.S. Provisional App. Ser. No. 63/383,558 filed on Nov. 14, 2022, which is incorporated herein by reference in its entirety.

### FIELD OF THE DISCLOSURE

The present disclosure relates generally to internal combustion engines, and more particularly, but not exclusively, to a pressure regulator valve for a fuel system of the internal combustion engine.

### BACKGROUND

Common rail direct fuel injection is commonly used on fueling systems for internal combustion engines, such as diesel engines. The common rail direct fuel system typically includes a low pressure pump operatively connected and attached to a high pressure pump. The low pressure pump directs fuel to the high pressure pump, which thereafter increases the fuel pressure to satisfy fueling pressure requirements. The pressurized fuel from the high pressure pump is sent to a rail that balances out the pressure per the number of connected fuel injectors, which spray the fuel into the engine.

The low pressure fuel pump typically includes a pressure regulator valve on the outlet side of the low pressure pump. The pressure regulator valve can be used to ensure an adequate supply of fuel is provided to the inlet of the high pressure pump. However, current pressure regulator valves may provide excess recirculation of fuel at higher engine speeds, which can result in excess power consumption, increased fuel temperature, and increased pressures in the low pressure pump circuit. As such, there exists a need for improvements in pressure regulator valves for fuel systems of internal combustion engines.

### SUMMARY

The present disclosure includes a pressure regulator valve (PRV) located upstream of the inlet of a pump in a fuel system for an internal combustion engine. In an embodiment, the pump is a lower or low pressure pump located upstream of a higher or high pressure pump of the fuel system. The pressure regulator valve is operable to regulate the flow of fuel from a fuel source to the inlet of the low pressure pump.

In an embodiment of the present disclosure, a fuel system for an internal combustion engine is provided. The fuel system includes a fuel pump having an inlet for receiving fuel from a fuel source. The fuel pump has an outlet for providing pressurized fuel. A bypass flow path extends from the outlet toward the inlet. The fuel system also includes a pressure regulator valve connecting the bypass flow path to the inlet. The pressure regulator valve includes a fuel passage that connects the fuel source to the inlet of the fuel pump and a plunger in the fuel passage. The plunger is displaced by fuel pressure in the bypass flow path to close the fuel passage in the pressure regulator in response to the fuel pressure in the bypass flow path exceeding a threshold pressure.

In an embodiment of the present disclosure, a pressure regulator valve for a fuel system pump is provided. The pressure regulator valve includes a plunger and an elongated body extending between a first end and an opposite second end. The elongated body defines a fuel passage, and the plunger is housed in the fuel passage. The elongated body includes an opening at the first end that is configured to receive fuel from a fuel pump bypass flow path, a valve inlet to the fuel passage between the first end and the second end that receives fuel from a fuel source, and a valve outlet between the first and second end that provides fuel from the fuel passage to the fuel system pump. The plunger is movable from a first position toward a second position in response to a pressure from the fuel in the fuel pump bypass flow path. In the first position, the plunger is positioned in the fuel passage to allow fuel from the fuel source to flow through the valve inlet into the fuel passage and through the valve outlet to the fuel system pump. In the second position, the plunger blocks the valve inlet and obstructs fuel flow from the fuel source through the valve inlet.

This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

The description herein makes reference to the accompanying drawings wherein like numerals refer to like parts throughout the several views, and wherein:

FIG. 1 is a schematic block diagram of an example fuel system for an internal combustion engine including a pressure regulator valve according to an embodiment of the present disclosure.

FIG. 2 is a schematic diagram showing a pressure relief valve upstream of the pressure regulator valve.

FIG. 3 is a perspective view of an embodiment of the pressure regulator valve of FIG. 1.

FIG. 4 is a longitudinal section view of the pressure regulator valve of FIG. 3.

FIG. 5 is a perspective view of a plunger housed in the pressure regulator valve of FIG. 3.

FIG. 6 is a section view showing the pressure regulator valve of FIG. 3 with the plunger in a first position not restricting fuel flow.

FIG. 7 is a section view showing the pressure regulator valve of FIG. 3 with the plunger in an intermediate position restricting fuel flow.

FIG. 8 is a section view showing the pressure regulator valve of FIG. 3 with the plunger in a second position preventing fuel flow.

### DETAILED DESCRIPTION OF ILLUSTRATIVE EMBODIMENTS

For the purposes of clearly, concisely and exactly describing illustrative embodiments of the present disclosure, the manner and process of making and using the same, and to enable the practice, making and use of the same, reference will now be made to certain exemplary embodiments, including those illustrated in the figures, and specific language will be used to describe the same. It shall nevertheless be understood that no limitation of the scope of the invention is thereby created, and that the invention includes and protects such alterations, modifications, and further applications of the exemplary embodiments as would occur to one skilled in the art.

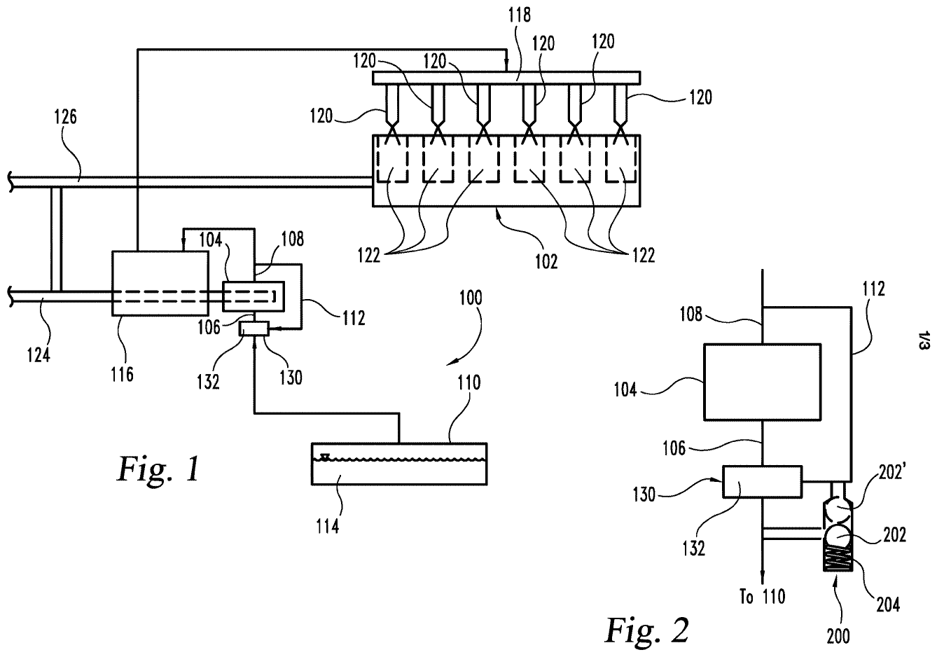

Referring to FIGS. 1-8, a fuel system 100 for an internal combustion engine 102 is illustrated. In an embodiment of the present disclosure, the fuel system 100 includes a fuel pump 104 having an inlet 106 for receiving fuel from a fuel source 110. The fuel pump 104 has an outlet 108 for providing pressurized fuel to the fuel system 100. Fuel system 100 includes a bypass flow path 112 extending from the outlet 108 toward the inlet 106. Fuel system 100 includes a pressure regulator valve 130 connecting the bypass flow path 112 to the inlet 106. The pressure regulator valve 130 includes a fuel passage 132 that fluidly connects the fuel source 110 to the inlet 106 of the fuel pump 104. Pressure regulator valve 130 also includes a plunger 134 in the fuel passage 132. The plunger 134 is displaced by fuel pressure in the bypass flow path 112 to close the fuel passage 132 in the pressure regulator valve 130 in response to the fuel pressure in the bypass flow path 112 exceeding a threshold pressure.

In an embodiment of the present disclosure, pressure regulator valve 130 for fuel pump 104 is shown. Pressure regulator valve 130 includes plunger 134 and a body 136 elongated between a first end 138 and an opposite second end 140. The body 136 defines fuel passage 132 therein, and the plunger 134 is located in the fuel passage 132. Body 136 includes an opening 142 at the first end 138. The opening 142 is configured to receive fuel from a fuel pump bypass flow path 112. Body 136 includes a valve inlet 144 to the fuel passage 132 configured to receive fuel from a fuel source. The valve inlet 144 is located on a side of body 136 between the first end 138 and the second end 140. Body 136 includes a valve outlet 146 from the fuel passage 132 configured to provide fuel from the fuel passage 132 to the fuel pump 104. The valve outlet 146 is located on the side of body 136 between the first end 138 and the second end 140. Plunger 134 is movable from a first position in the fuel passage 132 toward a second position in the fuel passage 132 in response to a pressurized fuel in the fuel pump bypass flow path 112. In the first position the plunger 134 allows fuel from the fuel source 110 to flow through the valve inlet 144 into the fuel passage 132 and through the valve outlet 146 to the fuel pump 104. In the second position the plunger 134 is located in the fuel passage 132 to block the valve inlet 144 and obstruct fuel flow into the fuel passage 132 from the fuel source 110.

Fuel system 100 in FIG. 1 is configured to provide fuel 114 from fuel source 110 to internal combustion engine 102. Fuel system 100 includes a first or low pressure pump 104 that pressurizes and provides fuel to an inlet of a second or high pressure pump 116. Low pressure pump 104 is upstream of high pressure pump 116. A cam shaft 124 can be provided to mechanically drive each of the low pressure pump 104 and the high pressure pump 116. The cam shaft 124 can be connected to and driven by an output shaft 126 of engine 102.

High pressure pump 116 further pressurizes the fuel and provides it to fuel rail 118, which distributes the pressurized fuel to a plurality of fuel injectors 120. Engine 102 includes cylinders 122 that each receive fuel from one or more of the fuel injectors 120 connected to rail 118. It should be understood that only some components of a high pressure fuel system 100 are shown in FIG. 1. Other details and components, such as priming pumps, filters, valves, drains, bypasses, plumbing, venturi devices, etc. are omitted for clarity and/or not being relevant to the present disclosure.

Inlet 106 of low pressure pump 104 receives fuel from the fuel source 110 through pressure regulator valve 130. The fuel is pressurized by fuel pump 104 and provided to the inlet of high pressure pump 116 and to bypass flow path 112. The flow of fuel into inlet 106 is controlled by the fuel pressure in bypass flow path 112 acting on pressure regulator valve 130, which is in the flow path from fuel source 110 to inlet 106. As used herein, inlet 106 may be any structure connected at the upstream side of fuel pump 104, such as a housing inlet for fuel pump 104 or a fuel line inlet connected to the housing of fuel pump 104.

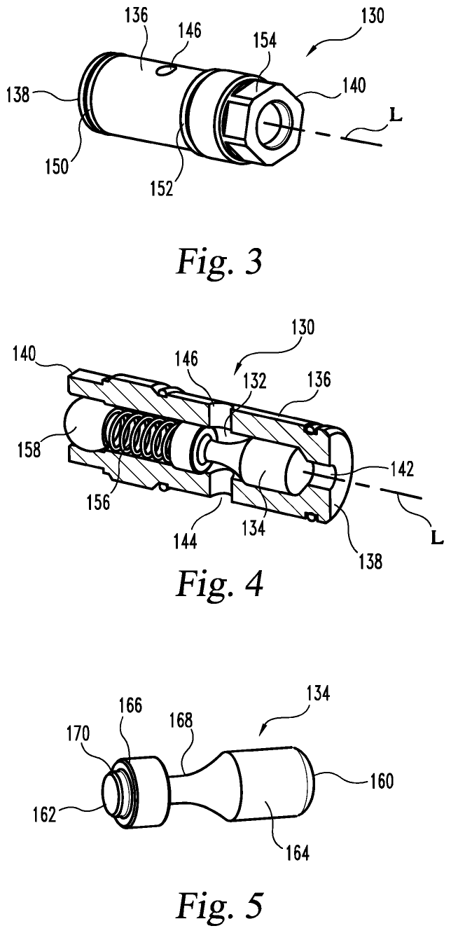

Referring to FIGS. 3-5, further details of pressure regulator valve 130 are shown. Pressure regulator valve 130 can be located at the inlet 106 of low pressure pump 104. In an embodiment, pressure regulator valve 130 is located upstream of a housing of low pressure pump 104. In an embodiment, pressure regulator valve 130 is integrated with the housing of low pressure pump 104.

Pressure regulator valve 130 includes a body 136 that is elongated and extends along longitudinal axis L between first end 138 and opposite second end 140. The elongated body 136 defines fuel passage 132 therein. Plunger 134 is located in the fuel passage 132 and also extends along and is movable along longitudinal axis L.

Body 136 includes a cylindrical shape between first and second ends 138, 140. Circular sealing rings 150, 152 can be provided around body 136 to provide a sealing engagement with a corresponding structure of fuel system 100 in which body 136 is placed. Second end 140 includes a hex shape 154 or other suitable configuration for engagement of a tool. Second end 140 can also be initially open for insertion and assembly of plunger 134 and biasing member 156 in fuel passage 132. The opening at second end 140 can thereafter be plugged with a plug ball 158 or other suitable closure device. In the illustrated embodiment, biasing member 156 is a coil spring, but any suitable biasing member is contemplated.

Elongated body 136 further includes opening 142 at the first end 138. The opening 142 is located on longitudinal axis L in the illustrated embodiment, and receives fuel from fuel pump bypass flow path 112. The pressurized fuel provided through opening 142 acts on the end of plunger 134 in fuel passage 132 and displaces plunger 134 in fuel passage 132 against biasing member 156, as discussed further below.

Body 136 includes valve inlet 144 to the fuel passage 132. Valve inlet 144 is positioned to receive fuel 114 from fuel source 110. The valve inlet 144 is located on a side of body 136 between the first end 138 and the second end 140. Body 136 includes valve outlet 146 from the fuel passage 132 configured to provide fuel from the fuel passage 132 to the inlet 106 of fuel pump 104. The valve outlet 146 is located on a side of body 136 between the first end 138 and the second end 140.

Plunger 134 extends from a first plunger end 160 to a second plunger end 162. The first plunger end 160 is oriented toward the first end 138 of body 136. The second plunger end 162 is engaged with biasing member 156, which biases the first plunger end 160 toward the first end 138 of the body 136. Plunger 134 is therefore normally biased so that first plunger end 160 contacts an inner surface of body 136 around opening 142.

Plunger 134 includes a first end portion 164 extending from first plunger end 160, and a second end portion 166 extending from second plunger end 162. A neck 168 extends between and connects first end portion 164 and second end portion 166. The neck 168 is tapered from the first end portion 164 toward the second end portion 166. In the illustrated embodiment, the neck 168 is trumpet shaped. Other shapes for neck 168 are also contemplated, such as frusto-conical shapes, stepped shapes, pyramid shapes, and other tapered shape.

First end portion 164 and second end portion 166 are cylindrical in shape to complement the interior shape of fuel passage 132. Second end portion 166 may include a stem 170 extending axially therefrom. Stem 170 can be configured to engage with biasing member 156 by stem 170 being positioned within biasing member 156. Other arrangements for coupling biasing member 156 to stem second end portion 166 are also contemplated.

Other embodiments contemplated other shapes and/or configurations for plunger 134. For example, plunger 134 could include a cylindrical neck between the end portions 164, 166. In another embodiment, plunger 134 is spherical or ball-shaped.

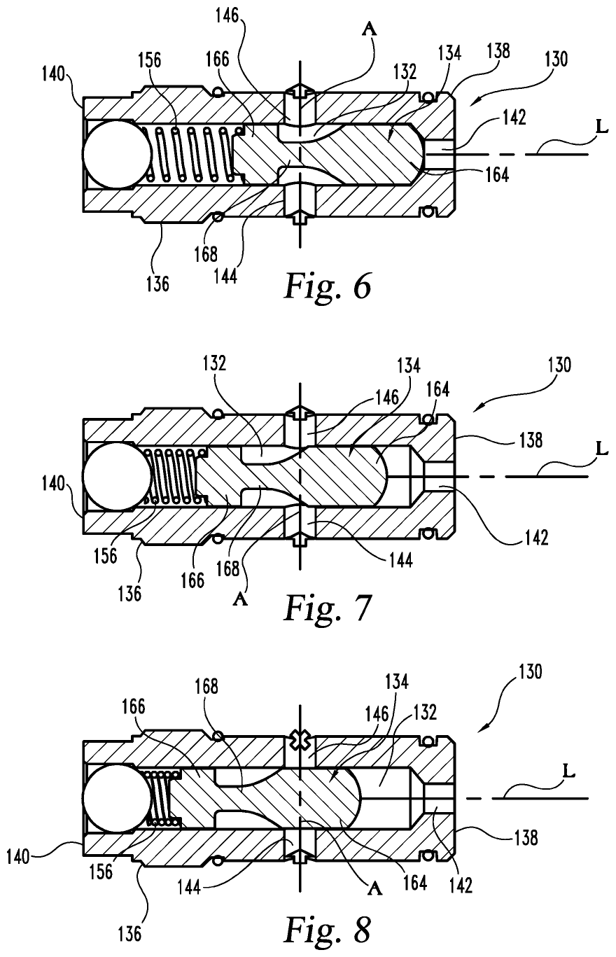

Referring further to FIGS. 6-8, the fuel passage 132 includes a first cross-sectional size along the interior of body 136 from first end 138 to second end 140. In the illustrated embodiment, the first cross-sectional size is constant along longitudinal axis L. In an embodiment, the cross-section of fuel passage 132 is not constant along longitudinal axis L. In an embodiment, the first end portion 164 and the second end portion 166 each include a second cross-sectional size that corresponds substantially to the first cross-sectional size of passage 132. As a result, the first end portion 164 and the second end portion 166 substantially occupy or fill fuel passage 132, and fuel flow around first end portion 164 and/or second end portion 166 in fuel passage 132 is eliminated or substantially reduced.

In the first position of plunger 134, the neck 168 is located between the valve inlet 144 and the valve outlet 146, and the fuel passage 132 extends around the neck 168. In the second position of plunger 134 that occurs due to fuel pressure in bypass flow path 112 acting on first end portion 164, the first end portion 164 of the plunger 134 is located between the valve inlet 144 and the valve outlet 146. The tapered shape of neck 168 provides a gradually decreasing flow volume between the valve inlet 144 and the valve outlet 146 around the neck 168 as the plunger moves 134 from the first position toward the second position.

Plunger 134 is movable from a first position in the fuel passage 132 toward a second position in the fuel passage 132 in response to a pressurized fuel in the fuel pump bypass flow path 112. In the first position the plunger 134 allows fuel from the fuel source 110 to flow through the valve inlet 144 into the fuel passage 132 and through the valve outlet 146 to the fuel pump 104. In the second position the plunger 134 is located in the fuel passage 132 to block the valve inlet 144 and obstruct fuel flow into the fuel passage 132 from the fuel source 110.

With plunger 134 in the second position obstructing fuel flow to fuel pump 104, pressure in bypass flow path 112 may continue to increase. As shown in FIG. 2, a pressure relief valve 200 can be provided between the bypass flow path 112 and an upstream side of the pressure regulator valve 130. The pressure relief valve 200 is configured to vent fuel from the bypass flow path 112 to the upstream side in response to the fuel pressure in the bypass flow path 112 exceeding a second pressure threshold. In an embodiment, the second pressure threshold is greater than the pressure threshold at which plunger 134 is displaced to the second position.

In an embodiment, pressure relief valve 200 includes a ball valve 202 with a biasing member 204 biasing ball valve 202 to the closed position, as indicated by 202′. In the open position, ball valve 202 is displaced to compress a biasing member 204, such as a spring, and allow fuel flow to be returned upstream of pressure regulator valve 130. The vented fuel flow can be returned to, for example, fuel source 110 until the pressure in bypass flow path 112 reduces sufficiently to allow biasing member 204 to close ball valve 202.

Other embodiments contemplated other configurations for pressure relief valve 200. For example, pressure regulator valve 130 itself could be provided with a venting structure to relieve pressure in bypass flow path 112 while plunger 134 is closed. Ball valve 202 could be replaced with any suitable pressure controlled valve member. In an embodiment, pressure relief valve 200 is integrated into the housing of the low pressure pump 104 along with the pressure regulator valve 130.

In an embodiment, the valve inlet 144 and the valve outlet 146 are substantially the same size. In an embodiment, valve inlet 144 and valve outlet 146 are the same size. In an embodiment, valve inlet 144 and valve outlet 146 are different sizes. In an embodiment, valve inlet 144 and valve outlet 146 are the same shape. In an embodiment, valve inlet 144 and valve outlet 146 are different shapes.

In an embodiment, opening 142 extends along longitudinal axis L of the elongated body 136. In an embodiment, the valve inlet 144 and the valve outlet 146 extend through the elongated body 136 orthogonally to the longitudinal axis L. In an embodiment, the valve inlet 144 and the valve outlet 146 extend through the elongated body 136 non-orthogonally to the longitudinal axis L. In an embodiment, the valve inlet 144 and the valve outlet 146 are aligned with one another along a second axis A that is orthogonal to the longitudinal axis L. In an embodiment, the valve inlet 144 and the valve outlet 146 are aligned with one another along a second axis A that is non-orthogonal to the longitudinal axis L.

Further written description of a number of example aspects of the present disclosure and embodiments thereof shall now be provided. It should be appreciated that any combination of one or more of the embodiments is contemplated.

According to one aspect of the present disclosure, a fuel system for an internal combustion engine is provided. The fuel system includes a fuel pump having an inlet for receiving fuel from a fuel source and an outlet for providing pressurized fuel. The fuel system also includes a bypass flow path extending from the outlet toward the inlet, and a pressure regulator valve connecting the bypass flow path to the inlet. The pressure regulator valve includes a fuel passage that fluidly connects the fuel source to the inlet of the fuel pump and a plunger in the fuel passage. The plunger is displaced by fuel pressure in the bypass flow path to close the fuel passage in the pressure regulator in response to the fuel pressure in the bypass flow path exceeding a threshold pressure.

In an embodiment, the pump is a low pressure pump and the fuel system includes a high pressure pump downstream of the low pressure pump.

In a further embodiment, the fuel system includes a rail connected to the high pressure pump. The rail distributes pressurized fuel to a plurality of fuel injectors of the internal combustion engine.

In yet a further embodiment, the low pressure pump and the high pressure pump are each driven by a cam shaft, and the cam shaft is driven by an output shaft of the internal combustion engine.

In an embodiment, the pressure regulator valve includes an opening connected to the bypass flow path, and the plunger is located between the opening and the fuel passage.

In an embodiment, the pressure regulator valve includes a valve inlet to the fuel passage and a valve outlet from the fuel passage. The valve inlet is connected to the fuel source, and the valve outlet is connected to the inlet of the fuel pump.

In a further embodiment, the plunger in the fuel passage is displaced by pressurized fuel in the bypass flow path from a first position to a second position. In the first position fuel is allowed to flow through the fuel passage from the valve inlet to the valve outlet and in the second position the plunger obstructs fuel flow from the valve inlet to the valve outlet and fluidly disconnects the fuel source from the inlet of the fuel pump.

In a further embodiment, the pressure regulator valve includes an opening in fluid communication with the bypass flow path.

In a further embodiment, the plunger is configured to progressively reduce fuel flow through the fuel passage from the valve inlet to the valve outlet as the plunger is displaced from the first position toward the second position.

In an embodiment, the fuel system includes a pressure relief valve between the bypass flow path and an upstream side of the pressure regulator valve. The pressure relief valve is configured to vent fuel from the bypass flow path to the upstream side in response to the fuel pressure in the bypass flow path exceeding a second pressure threshold greater than the pressure threshold.

In another aspect of the present disclosure, a pressure regulator valve for a fuel pump is provided. The pressure regulator valve includes a plunger and a body that is elongated between a first end and an opposite second end. The body defines a fuel passage therein, and the plunger is located in the fuel passage. The body includes an opening at the first end that is configured to receive fuel from a fuel pump bypass flow path. The body also includes a valve inlet to the fuel passage configured to receive fuel from a fuel source. The valve inlet is located on a side of the body between the first end and the second end of the body. The body also includes a valve outlet from the fuel passage configured to provide fuel from the fuel passage to the fuel pump. The valve outlet is located on the side of the body between the first end and the second end of the body. The plunger is movable from a first position in the fuel passage toward a second position in the fuel passage in response to a pressurized fuel in the fuel pump bypass flow path. In the first position the plunger allows fuel from a fuel source to flow through the valve inlet into the fuel passage and through the valve outlet to the fuel pump, and in the second position the plunger is located in the fuel passage to block the valve inlet and obstruct fuel flow into the fuel passage from the fuel source.

In an embodiment, the plunger extends from a first plunger end to a second plunger end. The first plunger end is oriented toward the first end of the body and the second plunger end is engaged with a biasing member. The biasing member is configured to bias the first plunger end toward the first end of the body.

In a further embodiment, the biasing member is a spring located in the body.

In an embodiment, the plunger includes a first end portion oriented toward the first end of the body, a second end portion oriented toward the second end of the body, and a neck connecting the first end portion to the second end portion.

In a further embodiment, in the first position the neck of the plunger is located between the valve inlet and the valve outlet and the fuel passage extends around the neck. In the second position the first end portion of the plunger is located between the valve inlet and the valve outlet.

In a further embodiment, the neck is tapered from the first end portion toward the second end portion so that a flow volume around the neck between the valve inlet and the valve outlet progressively decreases as the plunger moves from the first position toward the second position.

In a further embodiment, the fuel passage includes a first cross-sectional size. The first end portion and the second end portion each include a second cross-sectional size that corresponds substantially to said first cross-sectional size.

In a further embodiment, the opening, the valve inlet, and the valve outlet are substantially the same size.

In a further embodiment, the opening extends along a longitudinal axis of the body, and the valve inlet and the valve outlet extend through the body orthogonally to the longitudinal axis.

In yet a further embodiment, the valve inlet and the valve outlet are aligned with one another along a second axis that is orthogonal to the longitudinal axis.

While illustrative embodiments of the disclosure have been illustrated and described in detail in the drawings and foregoing description, the same is to be considered as illustrative and not restrictive in character, it being understood that only certain exemplary embodiments have been shown and described and that all changes and modifications that come within the spirit of the claimed inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A fuel system for an internal combustion engine, the fuel system comprising:
a fuel pump having an inlet for receiving fuel from a fuel source, the fuel pump having an outlet for providing pressurized fuel;
a bypass flow path extending from the outlet toward the inlet; and
a pressure regulator valve connecting the bypass flow path to the inlet, wherein the pressure regulator valve includes:
a fuel passage that fluidly connects the fuel source to the inlet of the fuel pump; and
a plunger in the fuel passage, wherein the plunger is displaced by fuel pressure in the bypass flow path to close the fuel passage in the pressure regulator in response to the fuel pressure in the bypass flow path exceeding a threshold pressure.

2. The fuel system of claim 1, wherein the pump is a low pressure pump and the fuel system includes a high pressure pump downstream of the low pressure pump.

3. The fuel system of claim 2, further comprising a rail connected to the high pressure pump, the rail for distributing pressurized fuel to a plurality of fuel injectors of the internal combustion engine.

4. The fuel system of claim 3, wherein the low pressure pump and the high pressure pump are each driven by a cam shaft, and the cam shaft is driven by an output shaft of the internal combustion engine.

5. The fuel system of claim 1, wherein the pressure regulator valve includes an opening connected to the bypass flow path, and the plunger is located between the opening and the fuel passage.

6. The fuel system of claim 1, wherein the pressure regulator valve includes:
a valve inlet to the fuel passage, the valve inlet being connected to the fuel source; and
a valve outlet from the fuel passage, the valve outlet being connected to the inlet of the fuel pump.

7. The fuel system of claim 6, wherein the plunger in the fuel passage is displaced by pressurized fuel in the bypass flow path from a first position to a second position, and in the first position fuel is allowed to flow through the fuel passage from the valve inlet to the valve outlet and in the second position the plunger obstructs fuel flow from the valve inlet to the valve outlet and fluidly disconnects the fuel source from the inlet of the fuel pump.

8. The fuel system of claim 7, wherein the pressure regulator valve includes an opening in fluid communication with the bypass flow path.

9. The fuel system of claim 7, wherein the plunger is configured to progressively reduce fuel flow through the fuel passage from the valve inlet to the valve outlet as the plunger is displaced from the first position toward the second position.

10. The fuel system of claim 1, further comprising a pressure relief valve between the bypass flow path and an upstream side of the pressure regulator valve, wherein the pressure relief valve is configured to vent fuel from the bypass flow path to the upstream side in response to the fuel pressure in the bypass flow path exceeding a second pressure threshold greater than the pressure threshold.

11. A pressure regulator valve for a fuel pump, the pressure regulator valve comprising:
a plunger; and
a body that is elongated between a first end and an opposite second end, the body defining a fuel passage therein, and the plunger is located in the fuel passage, wherein the body includes:
an opening at the first end, the opening configured to receive fuel from a fuel pump bypass flow path;
a valve inlet to the fuel passage configured to receive fuel from a fuel source, the valve inlet located on a side of the body between the first end and the second end of the body;
a valve outlet from the fuel passage configured to provide fuel from the fuel passage to the fuel pump, the valve outlet located on the side of the body between the first end and the second end of the body, wherein:
the plunger is movable from a first position in the fuel passage toward a second position in the fuel passage in response to a pressurized fuel in the fuel pump bypass flow path;
in the first position the plunger allows fuel from a fuel source to flow through the valve inlet into the fuel passage and through the valve outlet to the fuel pump; and
in the second position the plunger is located in the fuel passage to block the valve inlet and obstruct fuel flow into the fuel passage from the fuel source.

12. The pressure regulator valve of claim 11, wherein the plunger extends from a first plunger end to a second plunger end, and the first plunger end is oriented toward the first end of the body and the second plunger end is engaged with a biasing member, the biasing member being configured to bias the first plunger end toward the first end of the body.

13. The pressure regulator valve of claim 12, wherein the biasing member is a spring located in the body.

14. The pressure regulator valve of claim 11, wherein the plunger includes:
a first end portion oriented toward the first end of the body;
a second end portion oriented toward the second end of the body; and
a neck connecting the first end portion to the second end portion.

15. The pressure regulator valve of claim 14, wherein:
in the first position the neck of the plunger is located between the valve inlet and the valve outlet and the fuel passage extends around the neck; and
in the second position the first end portion of the plunger is located between the valve inlet and the valve outlet.

16. The pressure regulator valve of claim 14, wherein the neck is tapered from the first end portion toward the second end portion so that a flow volume around the neck between the valve inlet and the valve outlet progressively decreases as the plunger moves from the first position toward the second position.

17. The pressure regulator valve of claim 14, wherein:
the fuel passage includes a first cross-sectional size; and
the first end portion and the second end portion each include a second cross-sectional size that corresponds substantially to said first cross-sectional size.

18. The pressure regulator valve of claim 14, wherein the opening, the valve inlet, and the valve outlet are substantially the same size.

19. The pressure regulator valve of claim 14, wherein:
the opening extends along a longitudinal axis of the body; and
the valve inlet and the valve outlet extend through the body orthogonally to the longitudinal axis.

20. The pressure regulator valve claim 19, wherein the valve inlet and the valve outlet are aligned with one another along a second axis that is orthogonal to the longitudinal axis.
